(19) United States
(12) Patent Application Publication
(10) Pub. No.: US 2009/0064526 A1
(43) Pub. Date: Mar. 12, 2009

(54) Tape measure

(76) Inventors: Stuart David Farnworth, Westport, CT (US); James E. McCay, Fairfield, CT (US)

Correspondence Address: ALIX YALE & RISTAS LLP, 750 MAIN STREET, SUITE 1400, HARTFORD, CT, 06103, US

(21) Appl. No.: 11/899,502

(22) Filed: Sep. 6, 2007

(51) Int. Cl. G01B 3/10

(52) U.S. Cl. 33/767

(57) ABSTRACT

A tape measure employs a generally rounded housing which receives a retractable measuring tape that is coilable within the housing and biased towards the fully coiled position. An actuator button is depressable to fix the measuring tape at a selected extended position. A clip assembly is removably attachable to the tape measure for facilitating mounting the tape measure to a belt. The end of the tape measure includes a stop member that may be configured as a hook portion defining a nail catch. The hook portion also has a rubber overmold to prevent slippage.

### BACKGROUND

This application relates generally to general purpose tape measures. More particularly, this application relates to tape measures wherein the flexible measuring tape may be automatically retracted into a housing.

### SUMMARY

Briefly stated, a tape measure in a preferred form comprises a generally contoured rounded housing for an automatically retractable coiled measuring tape and a removably attachable clip assembly.

The removable clip assembly is preferably an integral one piece member having a polycarbonate or plastic composition which is flexible and easily mountable to the housing and dismountable from the housing. The clip assembly comprises a central disc-like base which integrally mounts a clip which is adapted to attach to a belt, pocket or similar apparel.

A pair of resilient retention arms extend in generally opposite directions from the base. The retention arms have inner surfaces which generally conform to surface portions of the rounded housing. The retention arms preferably have an arcuate form which, upon mounting of the clip assembly, engage opposed side portions of the housing. A hook-like support arm engages the underside of the housing. The three arms are angularly disposed around the base in a generally “T” shaped configuration. The end portions of at least two of the arms have a bifurcated form to facilitate mounting and dismounting of the housing from the clip assembly.

### BRIEF DESCRIPTION OF THE DRAWINGS

FIG. 1A is a perspective view of an embodiment of a tape measure;

FIG. 1B is a perspective view of a tape measure including a variation of the foot portion;

FIG. 2 is an interior view, portions removed, of the tape measusre FIG. 1A, illustrating the locking mechanism thereof;

FIG. 3 is an enlarged view of an embodiment of a hook portion end of the tape measure of FIG. 2;

FIG. 4 is a perspective bottom view of a portion of the tape measure of FIG. 3 and further incorporating an embodiment of a removable clip assembly (only partially illustrated);

FIG. 5A is a side view of the clip component of the removable clip assembly of FIG. 4;

FIG. 5B is an opposite side view of the clip component of FIG. 5A;

FIG. 5C is an end perspective view of the clip component of FIG. 5A;

FIG. 6 is a side view of the tape measure of FIG. 1 including the removable clip assembly of FIGS. 4 and 5A-C;

FIG. 7 is a perspective view of the tape measure and clip assembly of FIG. 6 further illustrating the removable clip assembly;

FIG. 8A is a front perspective view of a second embodiment of a clip attachment;

FIG. 8B is an opposite rear perspective view of the clip attachment of FIG. 8A;

FIG. 8C is an end view of the clip attachment of FIG. 8A;

FIG. 9A is a perspective side view of the tape measure of FIG. 1 and including a variation of the clip attachment of FIGS. 8A-8C;

FIG. 9B is a perspective view of the opposite side of the tape measure and clip attachment of FIG. 9A;

FIG. 9C is another perspective view of the tape measure and clip attachment of FIG. 9B; and

FIGS. 10A-10D are a series of side perspective views, partially in diagram form, of the tape measure and clip attachment of FIGS. 9A-9C that illustrate the steps involved in removing the clip attachment from the tape measure.

### DETAILED DESCRIPTION OF THE PREFERRED EMBODIMENTS

With reference to the drawings wherein like numerals represent like parts through the several figures, a tape measure is generally designated by the numeral 10. The tape measure includes a contoured, sculptured rounded housing 20 of generally disc-like form.

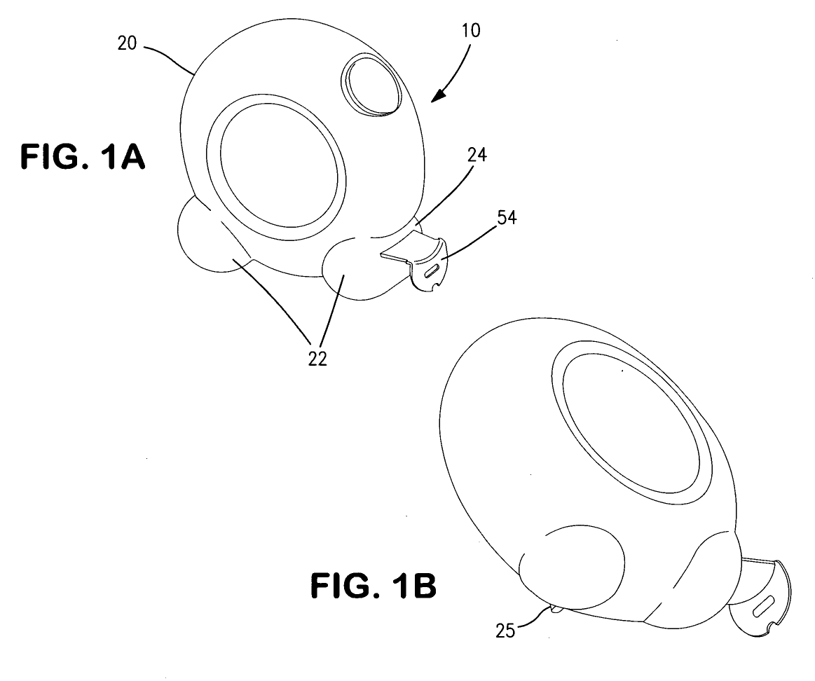

As seen in FIGS. 1 through 4, the housing includes two transversely spaced feet 22. Each foot has a generally bulbous sculpted form with a substantially flat bottom surface 23 which allows the tape measure to sit on edge in a substantially upright position as illustrated in the drawings. In another embodiment, a rib 25 (FIG. 1B) may be added to the bottom surface of the feet to increase the stability of the tape measure when sitting on edge.

The housing 2D may be constructed from a hard plastic material or moulded from a polymeric material. In addition, the exterior surface of the housing may be formed from a resilient polymer, such as an elastomer, synthetic rubber and natural. rubber which provides a soft feel when touched.

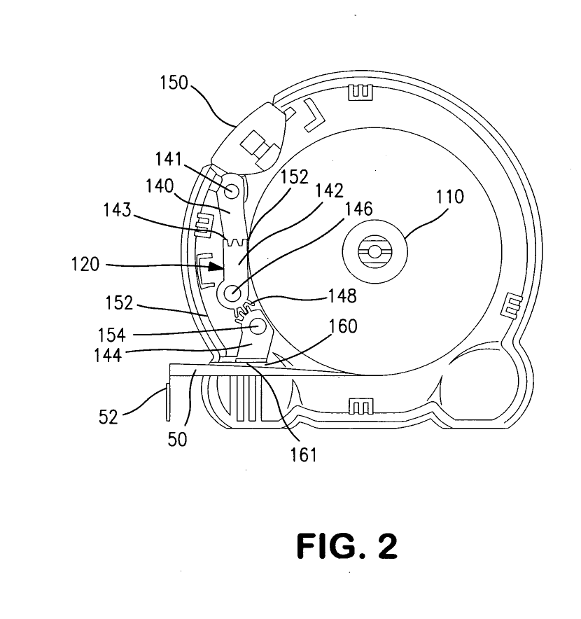

A measuring tape 50, partially illustrated in FIG. 2, is automatically coilable in the interior of the housing under a spring action in a generally conventional fashion. The housing includes a lower slot 24 through which the tape extends. The tape typically includes a stop 52 at its terminus which defines the reference point and engages the housing to prevent the tape from fully retracting into the housing. In one embodiment, the stop 52 takes the form of an inverted L-shaped hook. The surface 54 of the hook is covered with a rubberized spray paint. The surface covering functions to provide a substantially non-slip engagement against the reference edge of the material (such as metal, wood, etc.) to be measured.

As illustrated in FIG. 2, the tape measure 10 incorporates a gear linked locking mechanism designated generally by the numeral 120. When not in use, the measuring tape 50 is coiled about a spring-loaded central spool 110 which maintains the measuring tape in a fully coiled configuration. When the tape measure is in use, the locking mechanism 120 keeps the measuring tape 50 in a desired extended position via a gear-linked system that operates under a spring bias.

The locking mechanism 120 includes levers 140, 142 and 144 and an actuator button 150 which is depressible from exteriorly of the housing. Lever 140 is pivotal about pin 141 and includes teeth 143 which mesh with corresponding teeth of lever arm 142. Lever arm 142 is pivotal about pin 146 and includes teeth 148 which mesh with teeth 152 of lever arm 144 which is pivotal about pin 154. A spring biases lever 142 to rotate counterclockwise (as viewed in FIG. 2) which via the mesh against gear arm 160 engages the top of the tape to reversibly fix its position.

Upon depressing the actuator button 150, the lever arm 140 is cammed to rotate counterclockwise which in turn upwardly. pivots the gear arm 160 causing the tape to retract and recoil into the housing. In one preferred embodiment, the gear arm 160 has a distal rubber overmold portion 161 that facilitates the engagement of the gear against the tape.

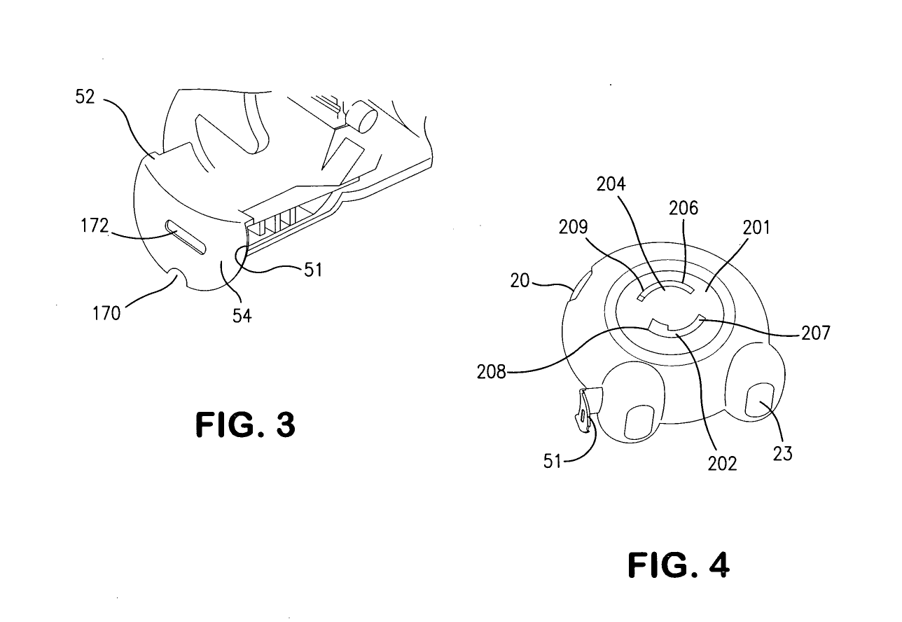

FIG. 3 illustrates an embodiment where the stop 52 is configured as a metal hook which is magnetized. In addition, the metal hook includes an arcuate cutout 170 which allows for the hook to be engaged by a nail, screw or similar appendage. The hook also preferably includes a transverse slot 172. It is also preferred that surface 54 of the hook is covered with a rubberized paint. This will prevent the hook from slipping when it engages the end or reference edge of the material to be measured, such as wood, metal, etc. In another preferred embodiment, only the underside surface 51 of the hook is covered with rubberized paint.

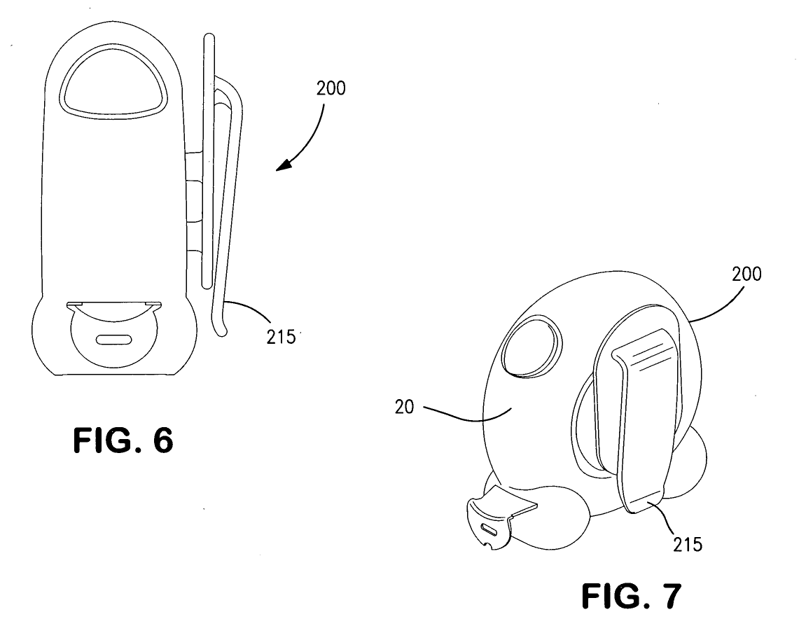

With reference to FIGS. 4 through 10, the tape measure may also be affixed with a removable clip assembly to facilitate clipping the tape measure to the belt or other apparel portion of the user. The present application discloses several embodiments of a removable clip assembly as described below.

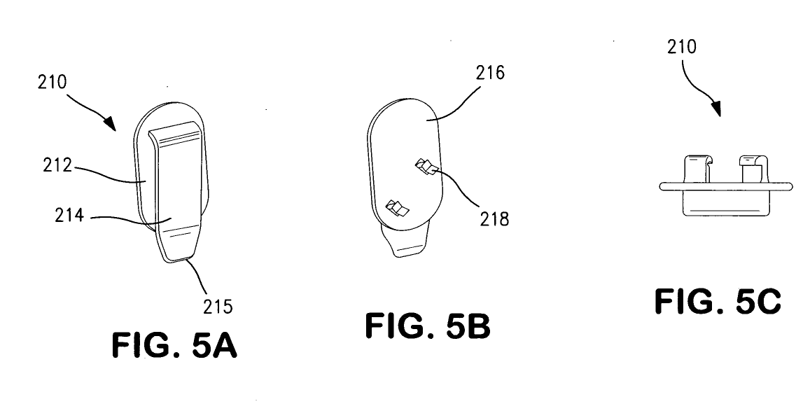

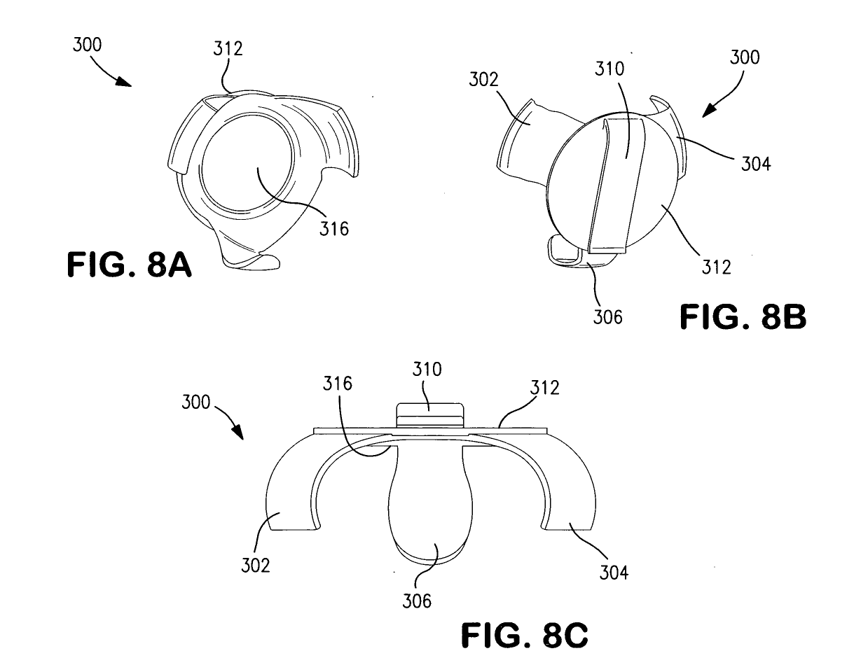

With reference to FIGS. 4-7, in a first embodiment of the removable clip assembly 200, one side of the tape measure includes an aluminum cover sheet 201 which is mounted to the central portion of the housing. As shown in FIG. 8, the aluminum cover sheet includes two arcuate openings 202 and 204 which extend approximately the arcuate length of 45° and include an enlarged portions 206, 208 at opposite portions thereof. From the enlarged portions, the arcuate openings extend into narrowed portions 207, 209. The configuration of the two arcuate openings provides the means for the removable engagement of the clip 210, illustrated in FIGS. 5A-5C, 6 and 7.

The clip 210 may be formed from polycarbon or other durable materials and, as shown in FIG. 5A, will preferably include a base 212 and a resilient clip portion 214. The clip portion has a first end secured to the base and projecting downwardly therefrom. The unsecured second end 215 of the clip portion may be rounded or contoured to facilitate engagement against the belt or other material. The clip 210 is secured to the tape measure via two integral snaps 218 located on the backside 216 of the base (FIG. 5B). The snaps are configured to be inserted into the arcuate openings 202, 204 by engaging the enlarged portions 206, 208 (as seen in FIG. 4). Turning the clip portion 450 in a clockwise direction will cause the snaps to slideably engage the narrowed portions of the openings and be securely, yet reversibly, locked in place.

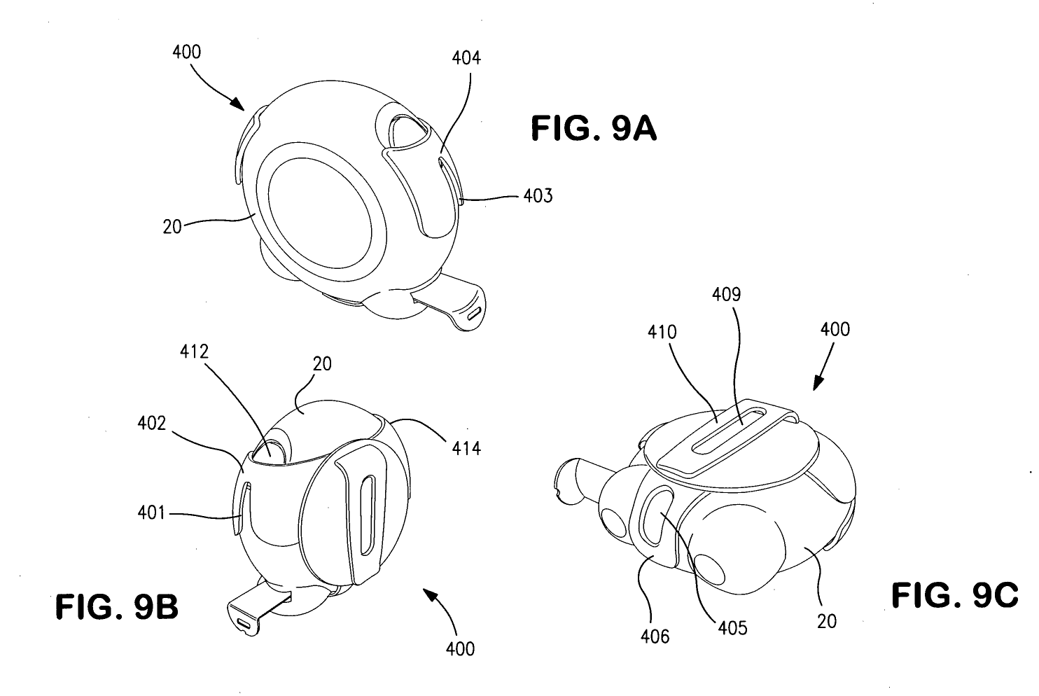

Other embodiments of a clip assembly are illustrated in FIGS. 8A-8C and 9A-9C. These embodiments are one piece modules comprised of a flexible and durable molded plastic material that partially encloses a portion of the housing. As shown in FIGS. 8A-8C, the clip assembly 300 is comprised of three substantially arcuate retention arms extending from a generally circular base portion 312 in a generally “T” shaped configuration. In the generally “T” shaped configuration, two of the arcuate arms 302, 304 are substantially laterally aligned, and the third arcuate arm 306 is disposed equidistantly from each of the two laterally aligned arms. The alignment of the substantially arcuate arms is such that, together, the arms function as hook-like claws to securely and removably enclose the tape measure against the inside surface 316 of the base portion. The generally circular base portion further outwardly mounts an integral resilient clip member 310 that is similar to the clip 210 shown in FIG. 5A.

FIGS. 9A-9C illustrate a variation of the clip assembly 300 of FIGS. 8A-8C. According to this embodiment, the clip assembly 400 is a molded one pieces plastic module. The clip assembly 400 has flexible retention components which more closely conform to the contours of the housing 20 upon attachment. At least some of the clip assembly components preferably include cut-out portions. As illustrated in FIG. 9C, the clip member 410 includes a narrow cut-out portion 409 along a portion of its length. The arcuate support arm 406 also includes a cut-out portion 405.

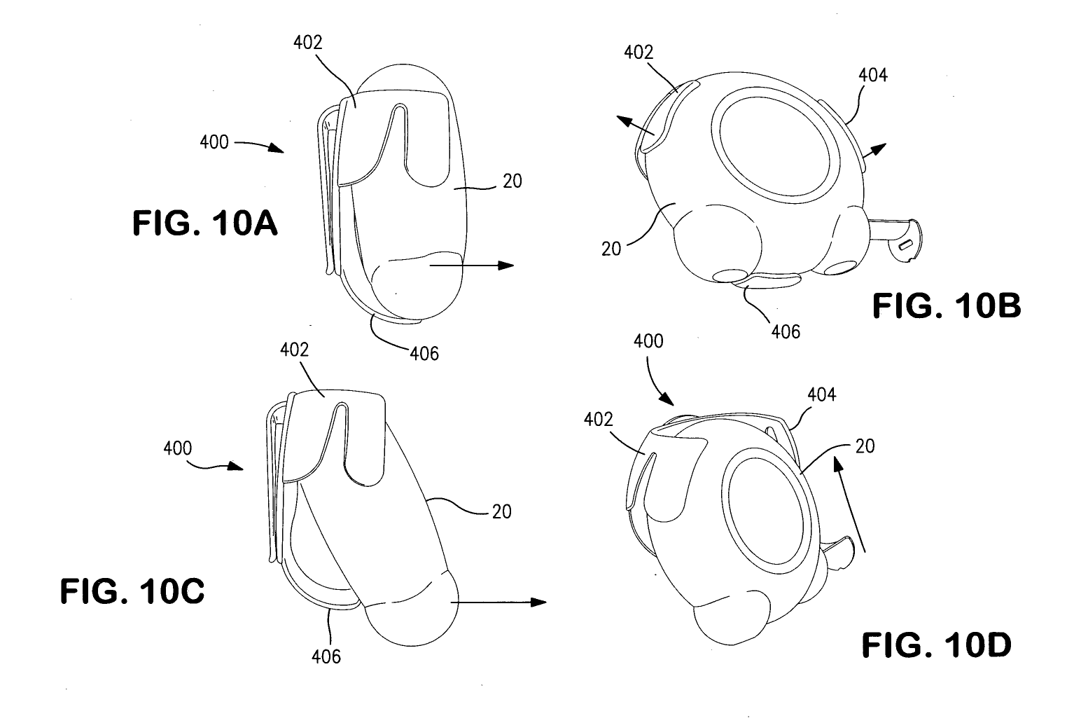

As shown in FIGS. 9A and 9B, arcuate retention arms 402, 404 also include substantially wedge shaped cut-out portions 401, 403 which bifurcate the end portions of the arms. The inner gripping surfaces of the arms 402, 404 define complex arcuate/rounded contoured retaining grips. The upper edges 412, 414 of the arms form a quasi-elliptical shape around an upper portion of the housing 20, as best illustrated in FIG. 9B. The cut-out portions reduce the weight of the clip assembly 400 and also provide areas of increased flexibility that function as pivoting points to efficiently facilitate the process of inserting and/or releasing the tape measure into and/or from the clip assembly 400 as shown in FIGS. 10A-10D.

With reference to FIGS. 10A-10D, the clip assembly 400 is especially adapted for efficient dismounting from the attached tape measure. With reference to the sequence from FIGS. 10A-10D, the housing is withdrawn from the clip assembly in the direction of the 10A arrow. The two retention arms 402, 404 will then swing out due to the flexibility of the bifurcated end portions in the direction of the FIG. 10B arrows. The lower portion of the tape measure will then clear the support arm as it is withdrawn in the arrow direction of FIG. 10C, and the clip assembly may be easily disengaged entirely from the tape measure housing in the direction of the FIG. 10D arrow. The clip assembly 400 may be relatively easily reattached to the tape measure by reversing the steps of FIGS. 10A-10D.

Exemplary embodiments illustrating a tape measure with a gear-linked locking mechanism and a clip assembly are described for purposes of explanation and are not intended as limitations of the invention therein. Accordingly, various modifications, adaptations and alternatives may occur to one skilled in the art without departing from the spirit and scope of the present invention.

1. A tape measure comprising:
a generally rounded housing defining an interior and a slot, said housing having a plurality of protrusions which allow the housing to rest in an upright orientation on a surface;
a measuring tape having a stop, said measuring tape being coilable and receivable at the interior of the housing and extendable outwardly through the slot;
a lock mechanism for locking the measuring tape in a fixed extended position and releasable to allow retraction into the housing; and
a clip assembly removably attachable to said housing and comprising at least two resilient retention arms which extend in generally opposite directions and have complex contoured arcuate inner surfaces which generally conform to double rounded opposed surface portions of said housing, and a support arm which engages opposed portions of said housing between said protrusions.

2. The tape measure of claim 1 wherein said plurality of protrusions are in the form of feet.

3. The tape measure of claim 1 wherein the protrusions are in the form of two bulbous feet.

4. The tape measure of claim 1 wherein said stop is a hook-like member mounted to said measuring tape.

5. The tape measure of claim 4 wherein the stop is at least partially covered by a rubberized material.

6. The tape measure of claim 5 wherein the rubberized material is applied as a paint.

7. (canceled)

8. The tape measure of claim 1 wherein said clip assembly comprises:
a base having a first surface and a second opposing surface;
a resilient clip member integrally extending from said first surface; and
said retention arms integrally extending from said base and configured to removably engage said tape measure against said second surface of said base.

9. The tape measure of claim 8 wherein said retention arms and said support arm are angularly disposed around said base portion in a generally “T” shaped configuration.

10. A tape measure comprising:
a generally rounded housing defining an interior and a slot at a lower portion thereof and having a portion adapted to rest in an upright orientation on a surface;
a measuring tape coilable and receivable at the interior of the housing and extendable outwardly through the slot and being spring biased to retractably coil into the housing;
a lock mechanism for locking the measuring tape in a fixed position of the tape at an extended position thereof and releasable to allow retraction into the housing; and
an acuator at the exterior of the housing and configured to be depressed manually for releasing the lock mechanism, wherein said lock mechanism comprises a first lever arm pivoted to said actuator, a second lever arm engageable with said first lever arm and being spring biased to rotate in a first clockwise position, said second lever arm engageable with a third lever arm pivoted at the interior of said housing, said third lever arm having an end engageable against the tape to prevent movement thereof, wherein depressing said actuator causes said second lever to pivot in a counterclockwise direction so that said end disengages from said tape to allow retraction of said tape into said housing.

11. The tape measure of claim 10, wherein the end of said third lever arm is covered with a rubber overmold material which is engageable against the top of the tape.

12. The tape measure of claim 10, and further comprising;
a plate having at least one arcuate opening mounted to said housing; and
a clip module comprising a base having a first surface and a second opposed surface, said first surface having at least one integrated prong configured to reversibly engage said at least one arcuate opening; said second surface mounting a resilient clip member with a first end secured to said second surface and a second end projecting downwardly therefrom.

13. A tape measure comprising:
a generally rounded housing defining an interior and a slot at a lower portion thereof and having a portion adapted to rest in an upright orientation on a surface;
a tape rule which is coilable and receivable at the interior of the housing and extendable outwardly through the slot; and
said housing having opposed side portions, an underside and generally opposed upper portions; and
a clip assembly having a support arm and a pair of resilient retention arms, said arms having generally arcuate shapes and being cooperatively retentively engageable with said housing side portions, wherein said support arm is engageable against said underside and said retention arms engage said opposed upper portions.

14. The tape measure of claim 13, wherein said clip assembly is formed from polycarbonate material.

15. The tape measure of claim 13, wherein said retention arms are projected generally in opposed angular directions and define inner contoured surfaces which engage generally the opposed side portions of said housing.

16. The tape measure of claim 15 wherein end portions of said retention arms are bifurcated.

17. The tape measure of claim 13, wherein said clip assembly further comprises a central base portion and said support arm and retention arms form a generally “T” shaped connection with said base portion.

18. The tape measure of claim 17, further comprising a clip integrally extending from said base portion.

19. (canceled)

20. The tape measure of claim 13, wherein said clip assembly is a one-piece module which comprises a central disc-like portion.
